(19) United States
(12) Patent Application Publication
(10) Pub. No.: US 2024/0309799 A1
(43) Pub. Date: Sep. 19, 2024

(54) ENGINE

(71) Applicant: KAWASAKI MOTORS, LTD., Hyogo (JP)

(72) Inventors: Kyohei IZUMI, Hyogo (JP); Yuji HIDA, Hyogo (JP); Jun TAKAGI, Hyogo (JP)

(73) Assignee: KAWASAKI MOTORS, LTD., Hyogo (JP)

(21) Appl. No.: 18/603,892

(22) Filed: Mar. 13, 2024

(30) Foreign Application Priority Data
Mar. 14, 2023 (JP) 2023-039656
Dec. 21, 2023 (JP) 2023-216220

(51) Int. Cl. F02B 1/04; F02B 75/12

(52) U.S. Cl. CPC F02B 1/04; F02B 2075/125

(57) ABSTRACT

An engine includes: ignition plugs which ignite an air-fuel mixture in combustion chambers; a power transmission member which transfers rotary motion of a crankshaft to a valve operation control mechanism for air intake and exhaust valves; and a transmission member housing space having the power transmission member disposed therein. The ignition plugs include first and second ignition plugs for each of the combustion chambers. The first ignition plug is located on a cylinder axis, and the second plug is arranged offset relative to the first ignition plug so as to be away from the transmission member housing space in a widthwise direction of the engine along which the crankshaft extends.

### CROSS REFERENCE TO THE RELATED APPLICATION

This application is based on and claims Convention priority to Japanese patent applications No. 2023-039656, filed Mar. 14, 2023 and No. 2023-216220, filed Dec. 21, 2023, the entire disclosures of which are herein incorporated by reference as a part of this application.

### BACKGROUND OF THE INVENTION

### Field of the Invention

The present disclosure relates, for example, to a multi-cylinder engine for use as a power source for a vehicle.

### Description of Related Art

An engine having a combustion chamber defined in a cylinder has been known in which two ignition plugs are disposed per cylinder to mitigate poor combustion (for example, JP 2009-162084 A). In the engine of JP 2009-162084 A, one of the two ignition plugs is located on a cylinder axis in a cylinder head whereas the other is located on one of the lateral sides, in an axial direction of the crankshaft, of the cylinder head.

The engine of JP 2009-162084 A is a single-cylinder engine. If the arrangement of ignition plugs of JP 2009-162084 A is applied to a multi-cylinder engine where a plurality of cylinders are arranged along an axial direction of the crankshaft, the size of the engine will become quite large in a widthwise direction thereof (or along the axial direction of the crankshaft).

### SUMMARY OF THE INVENTION

The present disclosure provides a multi-cylinder engine with successful reduction in width despite the arrangement of two ignition plugs per each cylinder.

An engine according to the present disclosure includes: a crankshaft extending in a widthwise direction of the engine and converting reciprocal motions of pistons to produce rotary motion; a crankcase supporting the crankshaft; a plurality of cylinders extending from the crankcase so as to protrude in a reciprocating direction of the pistons, arranged along the widthwise direction of the engine; a cylinder head coupled to protruding ends of the cylinders with the cylinders and the cylinder head defining combustion chambers therein; air intake ports which introduce intake air to the combustion chambers; air intake valves which open and close the air intake ports; exhaust ports which discharge exhaust gas from the combustion chambers; exhaust valves which open and close the exhaust ports; a valve operation control mechanism which opens and closes the air intake valves and the exhaust valves in a synchronous manner with the rotary motion of the crankshaft; a power transmission member which transfers the rotary motion of the crankshaft to the valve operation control mechanism; a transmission member housing space defined by the cylinders and the cylinder head, extending in the reciprocating direction, and having the power transmission member disposed therein; and ignition plugs which ignite an air-fuel mixture in the combustion chambers. The ignition plugs include first and second ignition plugs for each of the combustion chambers. The first ignition plug is located on the cylinder axis, and the second plug is arranged offset relative to the first ignition plug so as to be away from the transmission member housing space in the widthwise direction of the engine.

An engine according to the present disclosure includes two ignition plugs disposed per each cylinder, in particular, per each combustion chamber, and therefore can normally achieve reliable combustion, and also, can ensure ignition performance even in the event where one of the ignition plugs does not function correctly. As a result, the reliability of the engine is improved. Further, by disposing the second ignition plug away from the transmission member housing space, the space between the combustion chambers and a side of the engine opposite to the transmission member housing space can be filled therewith in a packed manner, thereby to reducing the width of the engine.

Any combinations of at least two features disclosed in the claims and/or the specification and/or the drawings should also be construed as encompassed by the present disclosure. Especially, any combinations of two or more of the claims should also be construed as encompassed by the present disclosure.

### BRIEF DESCRIPTION OF THE DRAWINGS

The present disclosure will be more clearly understood from the following description of preferred embodiments made by referring to the accompanying drawings. However, the embodiments and the drawings are given merely for the purpose of illustration and explanation, and should not be used to delimit the scope of the present disclosure, which scope is to be delimited by the appended claims. In the accompanying drawings, alike numerals are assigned to and indicate alike parts throughout the different figures, and:

FIG. 1 shows a side view of the right of an engine in accordance with a first embodiment of the present disclosure;

FIG. 2 shows a side view of the left of the engine;

FIG. 3 shows a front elevational view of the engine;

FIG. 4 shows a rear view of the engine;

FIG. 5 shows a top view of the engine;

FIG. 6 shows a vertical cross-sectional view of a cylinder head of the engine;

FIG. 7 shows a horizontal cross-sectional view of the cylinder head of the engine;

FIG. 8 shows a plan view of a cylinder block of the engine;

FIG. 9 shows a perspective view of an inlet unit of a circulation path of the engine; and

FIG. 10 shows a cross-sectional view of the inlet unit.

### DESCRIPTION OF EMBODIMENTS

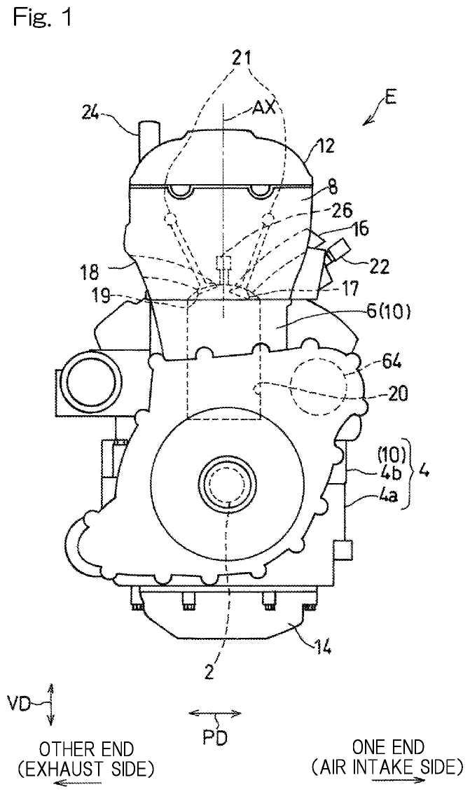

What follows is a description of preferred embodiments of the present disclosure made with reference to FIGS. 1 to 10. An engine E in the instant embodiment is a reciprocating engine and is used, for example, in an aircraft having a fuselage and a propeller disposed on a leading end of the fuselage. The engine E in this case is received within the fuselage and produces power to be transferred to the propeller. This is merely one of the non-limiting examples of the use of the engine E; for instance, the engine E can also be used as a power source for a ship. The engine E can also be used as a power source for wheeled vehicles including two-wheeled and four-wheeled vehicles.

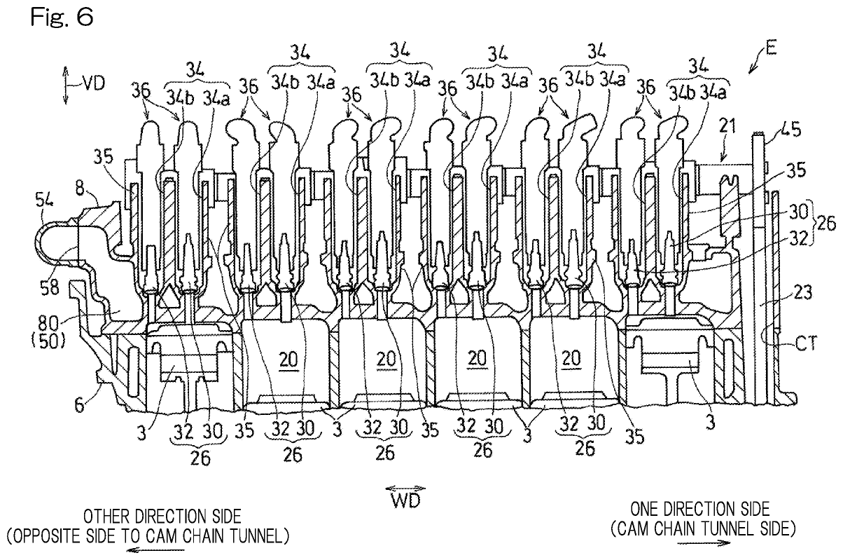

In the discussions that follow, the term “widthwise direction WD” refers to a direction in or along which a crankshaft 2 of the engine E extends. With respect to the widthwise direction WD, a “widthwise inside” refers to a side facing towards a center of the engine E in the widthwise direction, whereas a “widthwise outside” refers to a side facing away from the center of the engine E in the widthwise direction. The term “vertical direction VD” refers to a direction in or along which pistons 3 (FIG. 6) of the engine E reciprocate. The term “perpendicular direction PD” refers to a direction perpendicular to both the “widthwise direction” and the “vertical direction.”

The engine E in the instant embodiment is a six-cylinder engine having six cylinders 6 arranged along a direction in which the crankshaft 2 extends. It should be understood that the number of the cylinders is not so limited; for example, the number of the cylinders may be four. Further, while the engine E in the instant embodiment is a gasoline engine, gasoline is only one of the non-limiting examples of fuel.

The engine E includes a crankcase 4 supporting the crankshaft 2, the cylinders 6 extending from the crankcase 4 so as to protrude in a reciprocating direction of the pistons 3, and a cylinder head 8 coupled to protruding ends of the cylinders 6. The crankshaft 2 converts reciprocal motions of the pistons 3 to produce rotary motion. In the discussions that follow, with respect to the vertical direction VD (or a reciprocating direction of the pistons), the terms “upper” and “upward” refer to a side on which the cylinders 6 protrude from the crankcase 4, whereas the terms “lower” and “downward” refer to an opposite side thereto.

The crankcase 4 is formed of two upper and lower sub-parts including a lower crankcase 4a and an upper crankcase 4b. In the instant embodiment, the upper crankcase 4b and the cylinders 6 are formed as one piece by being cast in a die. However, the upper crankcase 4b and the cylinders 6 may alternatively be independent units. In the discussions that follow, the one-piece unit including the upper crankcase 4b and the cylinders 6 will be referred to as a cylinder block 10.

The engine E also includes a head cover 12 coupled to an upper end of the cylinder head 8 and an oil pan 14 coupled to a lower end of the crankcase 4. The cylinder head 8 and the cylinder head cover 12 define a cam chamber. The oil pan 14 serves as a reservoir of oil which represents an engine lubricant fluid.

The cylinder head 8 has air intake ports 16 and exhaust ports 18 which are open to one end side (i.e., the right side of FIG. 1) and the other end side (i.e., the left side of FIG. 1), respectively, of the cylinder head 8 in the perpendicular direction PD. In the discussions that follow, the terms “air intake side” and “exhaust side” refer to a side of the engine E where the air intake ports are located and a side of the engine E where the exhaust ports are located in the perpendicular direction PD, respectively.

The air intake ports 16 and the exhaust ports 18 represent passages defined inside the cylinder head 8. Upstream ends of the air intake ports 16 are open to the one end side of the cylinder head 8 in the perpendicular direction PD, whereas downstream ends of the air intake ports 16 are open to the combustion chambers 20 within the cylinders 6. Upstream ends of the exhaust ports 18 are open to the combustion chambers 20 within the cylinders 6, whereas downstream ends of the exhaust ports 18 are open to the other end side of the cylinder head 8 in the perpendicular direction PD. The air intake and exhaust ports 16, 18 are formed for each of the cylinders. The air intake ports 16 introduce ambient air as intake air to the combustion chambers 20. The exhaust ports 18 discharge exhaust gas from the combustion chambers 20.

The engine E in the instant embodiment includes air intake valves 17 which open and close the air intake ports 16 and exhaust valves 19 which open and close the exhaust ports 18. A valve operation control mechanism 21 opens and closes the air intake valves 17 and the exhaust valves 19. In the instant embodiment, two of the air intake valves 17 and two of the exhaust valves 19 are provided for each of the cylinders.

The valve operation control mechanism 21 is operable to open and close the air intake valves 17 and the exhaust valves 19 in a synchronous manner with the rotary motion of the crankshaft 2. The valve operation control mechanism 21 in the instant embodiment comprises independent cam shafts 21 on the air intake side and the exhaust side.

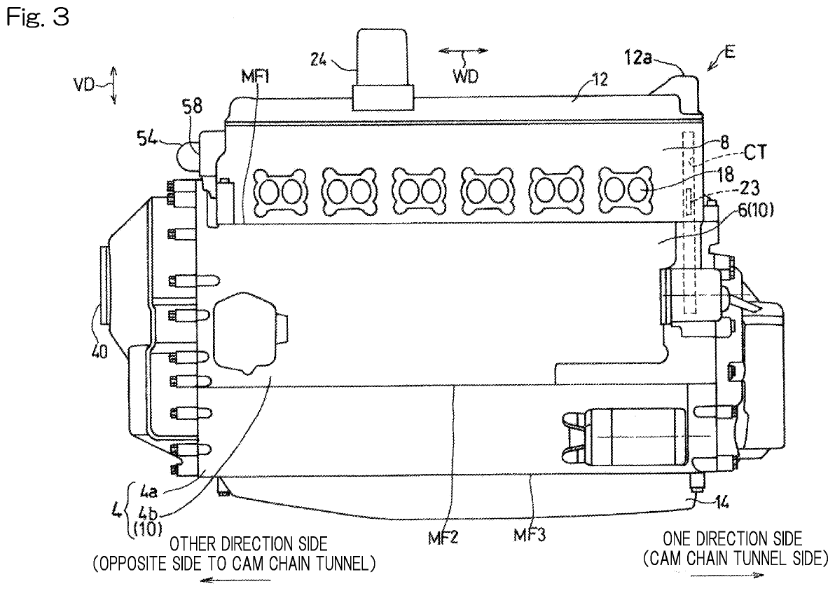

Turning to FIG. 3, the engine E includes a power transmission member 23 which transfers the rotary motion of the crankshaft 2 to the cam shafts 21 (i.e., the valve operation control mechanism). The power transmission member 23 in the instant embodiment comprises a cam chain. It should be understood that a cam chain is only one of the non-limiting examples of the power transmission member 23; for example, the power transmission member 23 can comprise a shaft drive.

The power transmission member 23 (or the cam chain) is disposed in the transmission member housing space CT. The transmission member housing space CT in the instant embodiment comprises a cam chain tunnel CT in which the cam chain 23 is housed. The cam chain tunnel CT is defined by the cylinders 6 and the cylinder head 8 and extends in the reciprocating direction VD. In the instant embodiment, the cam chain tunnel CT is located at one end of the engine E in the widthwise direction WD of the engine.

In the discussions that follow, a side of the engine E in the widthwise direction WD of the engine, where the cam chain tunnel CT is located (or a cam chain tunnel-side), will be referred to as one side of the engine E in the widthwise direction WD of the engine, whereas an opposite side thereto (or a counter-cam chain tunnel-side) will be referred to as the other side of the engine E in the widthwise direction WD of the engine.

The cylinder head cover 12 is partially bulged on one side thereof in the widthwise direction WD of the engine to enclose a sprocket 45 (FIG. 6) around which the cam chain 23 is wrapped within the cam chain tunnel CT. That is, the cylinder head cover 12 has an end, on the one side thereof in the widthwise direction WD of the engine, which is formed with a bulged section 12a that is bulged in the reciprocating direction.

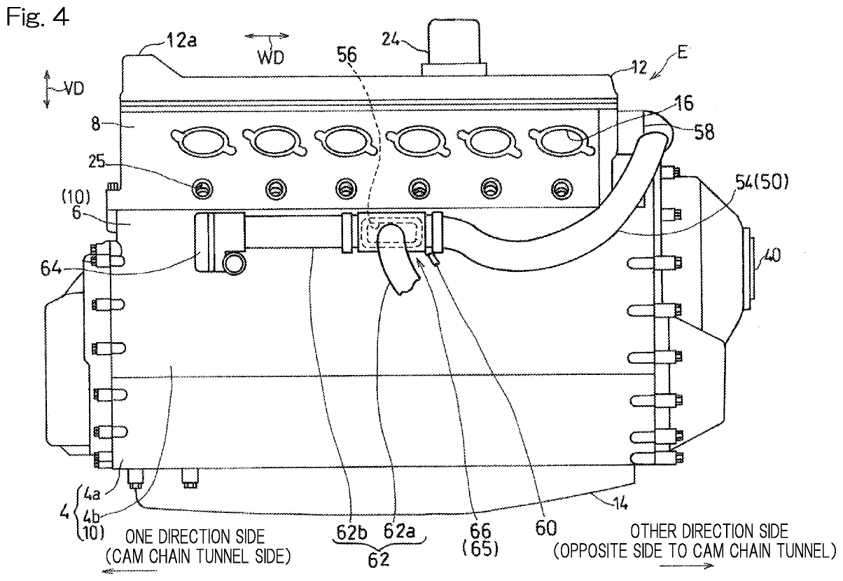

Turning to FIG. 1, the engine E in the instant embodiment is a direct injection engine in which fuel is directly injected into the combustion chambers 20. More specifically, the engine E includes direct injection injectors 22 which inject fuel into the combustion chambers 20 and a high-pressure pump 24 which pumps the fuel to the direct injection injectors 22. In the instant embodiment, the direct injection injectors 22 are fitted to an air intake-side of the cylinder head 8. The direct injection injectors 22 are also each formed for a respective one of the cylinders. It should be noted that injector fitting holes 25 via which the direct injection injectors 22 are fitted are depicted in FIG. 4. In addition to the direct injection injectors 22, the engine E in the instant embodiment also includes port injectors that provide fuel injection via the air intake ports 18.

Turning again to FIG. 1, the high-pressure pump 24 is fitted to the head cover 12. The high-pressure pump 24 extends from the head cover so as to protrude in the reciprocating direction PD. That is, the high-pressure pump 24 represents a protruding part coupled to the cylinder head cover 12 so as to protrude from the head cover 12. In the instant embodiment, the high-pressure pump 24 is arranged on an exhaust side-portion of an upper side of the head cover 12. Accordingly, the high-pressure pump 24 is driven by exhaust side-components of the valve operation control mechanism 21. However, the high-pressure pump 24 may alternatively be driven by air intake-side components of the valve operation control mechanism 21.

Ambient air is delivered via the air intake ports 16 as intake air to the combustion chambers 20. Concurrently, the fuel is injected by the direct injection injectors 22 into the combustion chambers 20, thereby forming an air-fuel mixture. The air-fuel mixture in the combustion chambers 20 is ignited by the ignition plugs 26 for combustion. Exhaust gas from the combustion is discharged out of the engine via the exhaust ports 18. The details of the ignition plugs 26 will be discussed later.

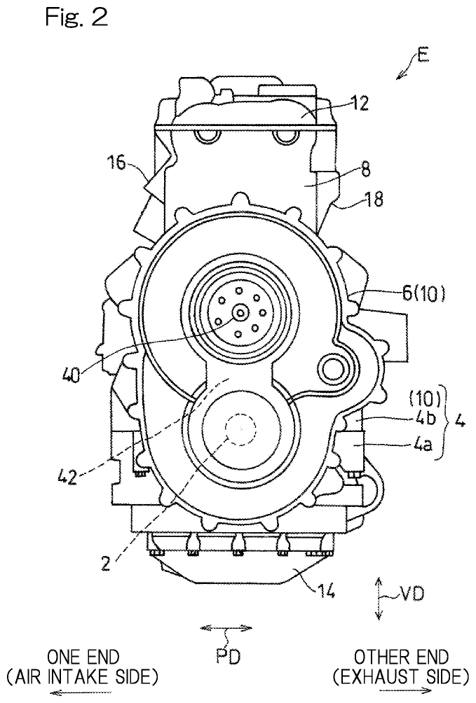

As illustrated in FIG. 3, an output shaft 40 is provided on the other end side of the engine E in the widthwise direction WD of the engine. In the instant embodiment, the output shaft 40 is located at a side of the engine E opposite to the cam chain tunnel CT in the widthwise direction ED of the engine. Rotational power of the crankshaft 2 is transmitted to the output shaft 40 with a reduced speed through a speed reducer mechanism 42 (FIG. 2). The output shaft 40 connects to, for example, a propeller of an aircraft or a wheel of a wheeled vehicle, either directly or via one or more power transmission components.

The engine E in the instant embodiment can be installed to a vehicle in an upright position, that is, in such a position that the reciprocating direction VD (or the axes of the pistons) is aligned with a vertical direction. By orienting the engine E in an upright position, the engine E can be kept in a better balance along the perpendicular direction PD. It also results in less constraints on the layout of air intake and exhaust systems and enhances freedom of design, as compared to when the engine is installed with the axes of the pistons inclined relative to the vertical direction VD.

### (Ignition Plugs)

The ignition plugs 26 will be discussed. The ignition plugs 26 of an engine E according to the present disclosure comprise a plurality of ignition plugs. In the instant embodiment, the ignition plugs 26 of the engine E include first ignition plugs 30 and second ignition plugs 32, as shown in FIG. 6. In particular, an engine E according to the present disclosure includes two ignition plugs 30, 32 for each of the cylinders. In the instant embodiment, there are six cylinders with twelve ignition plugs 26. For instance, the first and second ignition plugs 30, 32 are supported on the cylinder head 8.

In the instant embodiment, within each of the cylinders, the ignition timings for the two ignition plugs 30, 32 are identical. That is, the two ignition plugs 30, 32 are energized in unison. Moreover, the two ignition plugs 30, 32 are configured such that one of them 30 (32) can provide at least a minimum required ignition performance even when the other of them 32 (30) does not function correctly.

The provision of two ignition plugs 30, 32 disposed per each cylinder can normally achieve reliable combustion, and also, can ensure ignition performance even in the event where one of the ignition plugs does not function correctly. As a result, the reliability of the engine E is improved. Such an engine E is especially preferred for use in an aircraft.

The first ignition plugs 30 are centrally disposed in the cylinders. More specifically, the first ignition plugs 30 are located on axes AX of the cylinders. Meanwhile, the second ignition plugs 32 are arranged displaced relative to the first ignition plugs 30 in the widthwise direction WD of the engine. More specifically, the second ignition plugs 32 are arranged offset towards the other side thereof—that is, arranged offset so as to be away from the cam chain tunnel CT—in the widthwise direction ED of the engine. The total of six, second ignition plugs 32 are arranged offset on the same side in the widthwise direction WD of the engine.

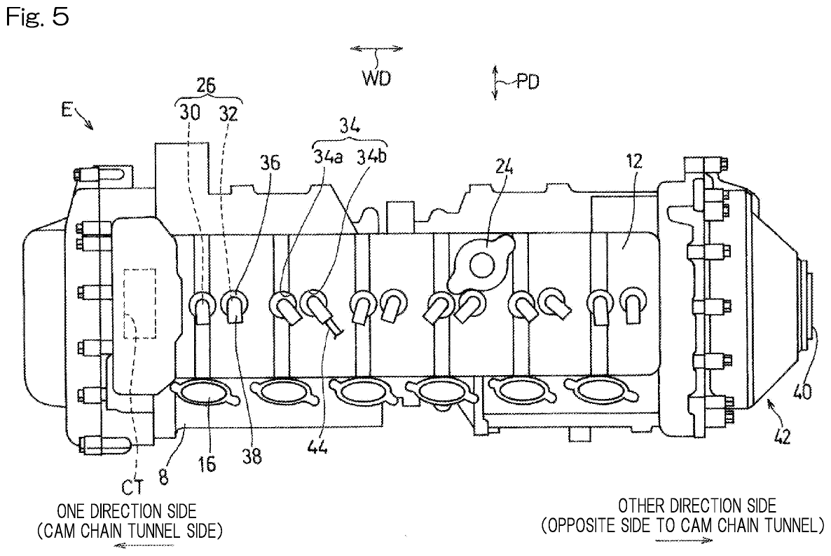

As illustrated in FIG. 5, the second ignition plugs 32 coincide in position with the first ignition plugs 30 in the perpendicular direction PD such that the first and second ignition plugs 30, 32 are arranged aligned in the widthwise direction WD of the engine. As illustrated in FIG. 6, the two ignition plugs 30, 32 extend parallel to each other, that is, parallel to the reciprocating direction VD.

By thus disposing the second ignition plugs 32, the distances between the combustion chambers 20 and the cam chain tunnel CT can be shortened. Further, since the second ignition plugs 32 are disposed away from the cam chain tunnel CT, the width of the engine E can be successfully reduced. In the instant embodiment, the second ignition plugs 32 are offset on the same side (or towards the other side thereof in the widthwise direction WD) for each of the cylinders. If the second ignition plugs 32 were offset in different directions for different cylinders, the second ignition plugs 32 for adjoining cylinders might interfere with each other. In the instant embodiment, since the second ignition plugs 32 are not offset in different directions for different cylinders, the second ignition plugs 32 for adjoining cylinders do not interfere with each other.

Accordingly, second ignition plugs 32 according to the present disclosure are arranged in positions offset relative to the axes AX of the cylinders so as to be away from the cam chain tunnel CT. Disposing the second ignition plugs 32 away from the cam chain tunnel CT allows a region dividing the cylinder head 8 and the cam chain 23 to be formed, thus, helping create spaces where the plugs can be inserted.

Plug holes 34 are defined in the cylinder head 8 and the head cover 12 so as to extend in the reciprocating direction VD. The plug holes 34 are defined by cylindrical bosses 35 extending in the reciprocating direction VD. Cords 44 of the ignition plugs 30, 32 are arranged in the plug holes 34. Upper ends of the plug holes 34 are closed with plug caps 36 in a water-proof fashion.

There is a concern that, if the temperature inside the bosses 35 defining the plug holes 34 increases, the plug caps 36 may come off when subjected to thermal expansion or vibrations from the engine. Hence, to prevent the plug caps 36 from coming off, the plug caps 36 are provided with breath openings 38 for vent and relief of air therethrough. For instance, the breath openings 38 are defined by cylindrical pipe members having hollow bores in communication with the plug holes 34 on one end and the external environment on the other end thereof.

The breath openings 38 for the ignition plugs 26 are individually defined for the different ignition plugs 26. Thus, in the instant embodiment, there are twelve breath holes 38, that is, as many breath holes 38 as the ignition plugs 26 as shown in FIG. 5. In the instant embodiment, the breath openings 38 are open to the air intake side. The reason why the breath openings 38 are oriented towards the air intake side is to avoid interference with the aforementioned high-pressure pump 24 which is arranged on an exhaust side-portion of an upper side of the head cover 12. If it is wished to arrange the high-pressure pump 24 on the air intake side—that is, if the high-pressure pump 24 is to be driven by the air intake-side components of the valve operation control mechanism—the breath openings 38 should be open to the exhaust side. In the instant embodiment, the cords 44 for the ignition plugs 26 are drawn out away from the high-pressure pump 24, which represents the protruding part, in the perpendicular direction PD.

As described thus far, in the instant embodiment, the first ignition plugs 30 are centrally disposed in the cylinders (or located on the axes AX of the cylinders), and the second ignition plugs 32 for all of the cylinders are offset so as to be away from the cam chain tunnel CT. Further, the breath openings 38 for the ignition plugs 26 are also individually defined for the different ignition plugs 30.

### (Cooling Structure for Ignition Plugs)

A cooling structure for the ignition plugs 26 will be discussed. The engine E in the instant embodiment is a liquid-cooled engine in which a liquid coolant is circulated to cool to-be-cooled portions of the engine E. The to-be-cooled portions comprise portions around the plug holes 34 of the ignition plugs 26, including the bosses 35. In the instant embodiment, water is used as the liquid coolant.

As illustrated in FIG. 4, a circulation path 50 for the liquid coolant in the engine E of the instant embodiment includes an inner passage 52 and an outer passage 54. The inner passage 52 is a passage defined inside the engine E, and has an entrance at an inlet 56 through which it enters the inside of the engine and an exit at an outlet 58 via which it exits to the outside of the engine. The outer passage 54 is formed of a piping disposed outside of the engine E, and has an upstream end that connects to the outlet 58 and a downstream end that connects to the inlet 56.

The outer passage 54 is provided with a thermostat 60. The thermostat 60 senses a temperature of the liquid coolant which circulates through the engine in order to direct the liquid coolant back to the inner passage 52 through the inlet 56 when the temperature of the liquid coolant is low and direct the liquid coolant to a radiator circulation passage 62 when the temperature of the liquid coolant is high. After dissipating heat away at a radiator, the liquid coolant flows back to the inlet 56 through the radiator circulation passage 62 and is delivered to the inner passage 52. Hence, the thermostat 60 is operable to regulate a temperature of the liquid coolant. The thermostat 60 is accommodated in a thermostat case 65.

The radiator circulation passage 62 includes an upstream pathway 62a going towards the radiator (not shown) from the thermostat 60 and a downstream pathway 62b going towards the inlet 56 from the radiator. The downstream pathway 62b is provided with a liquid coolant pump 64. The liquid coolant pump 64 is driven by the rotary power from the crankshaft 2 to force the liquid coolant in circulation.

In the instant embodiment, the inlet 56 of the circulation path 50 is defined in an air intake-side portion of a wall surface of the cylinder block 10, and the outlet 58 of the circulation path 50 is defined in one of the opposite ends of the cylinder head 8 in the widthwise direction WD of the engine. More specifically, the inlet 56 of the circulation path 50 is centrally defined in the air intake-side portion of the wall surface of the cylinder block 10 in the widthwise direction WD of the engine, and the outlet 58 of the circulation path 50 is located at an end of the engine E opposite to the cam chain tunnel CT (or at the other end of the engine E) in the widthwise direction WD of the engine.

A coupling 66 is fitted on the inlet 56 of the circulation path 50. In the instant embodiment, the thermostat case 65 and the coupling 66 are constructed as one piece to form an inlet unit UN. The inlet unit UN is detachably fitted to the cylinder block 10 and includes the thermostat 50 which is received therein. The outer passage 54 and the upstream pathway 62a and the downstream pathway 62b of the radiator circulation passage 62 connect to the inlet unit UN.

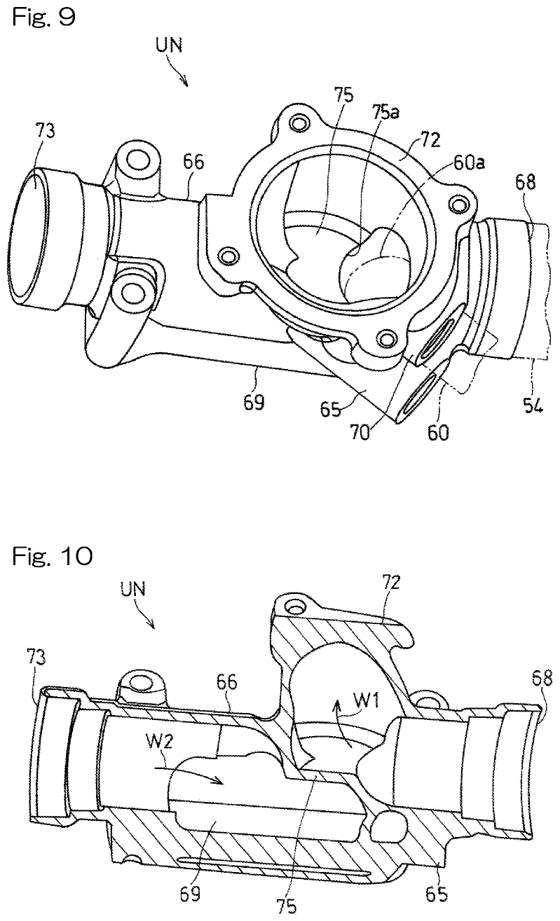

As illustrated in FIG. 9, the inlet unit UN includes a first connection 68 to which the outer passage 54 connects and a thermostat mount 70 to which the thermostat 60 is mounted. The inlet unit UN also includes a second connection 72 to which the upstream pathway 62a of the radiator circulation passage 62 connects and a third connection 73 to which the downstream pathway 62b connects. The inlet unit UN also has an opening 69 formed therein to communicate with the inlet 56 of the circulation path 50.

As illustrated in FIG. 10, the inlet unit UN includes a divider wall 75 in the interior of the inlet unit UN. The divider wall 75 divides the internal space of the inlet unit UN into segments so as to prevent the liquid coolant flow W1 going into the upstream pathway 62a of the radiator circulation passage 62 from meeting the liquid coolant flow W2 incoming from the downstream pathway 62b of the radiator circulation passage 62.

As illustrated in FIG. 9, the divider wall 75 has a communication aperture 75a formed therein to allow the outer passage 54 to communicate with the upstream pathway 62a of the radiator circulation passage 62, and a valve 60a for the thermostat 60 is fitted to the communication aperture 75a. The valve 60a is in a closed state when the temperature of the liquid coolant is low, and lets the liquid coolant W from the outer passage 54 flow towards the inlet 56 of the circulation path 50 via the opening 69. As the temperature of the liquid coolant increases, the opening of the valve 60a gradually increases so as to let the liquid coolant pass through the second connection 72 and into the upstream pathway 62a of the radiator circulation passage 62 to which the second connection 72 connects.

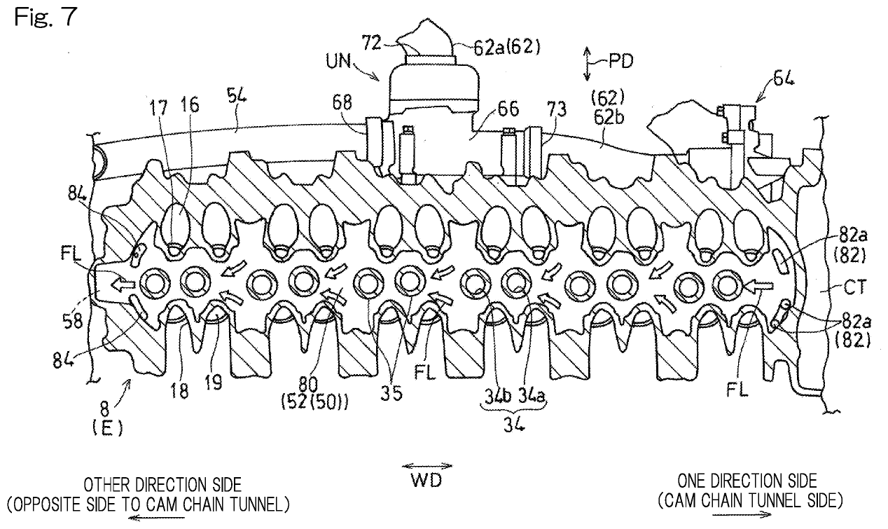

The inner passage 52 of the circulation path 50 is defined in the cylinders 6 and the cylinder head 8. Turning to FIG. 7, the inner passage 52 comprises a plug circulation passage 80. The liquid coolant circulates through the plug circulation passage 80 to cool portions around the plug holes 34 for the ignition plugs 26—in particular, the bosses 35 for plug holes 34a for the first ignition plugs 30 and the bosses 35 for plug holes 34b for the second ignition plugs 32.

The plug circulation passage 80 is defined in the cylinder head 8 and extends in the widthwise direction WD of the engine. In the instant embodiment, the liquid coolant flows through the plug circulation passage 80 from one side thereof (or the cam chain tunnel-side) to the other side thereof (or the counter-cam chain tunnel-side) in the widthwise direction WD. In other words, the liquid coolant flows through the plug circulation passage 80 towards the outlet 58 of the circulation path 50 that is located on the other side thereof (or the counter-cam chain tunnel-side).

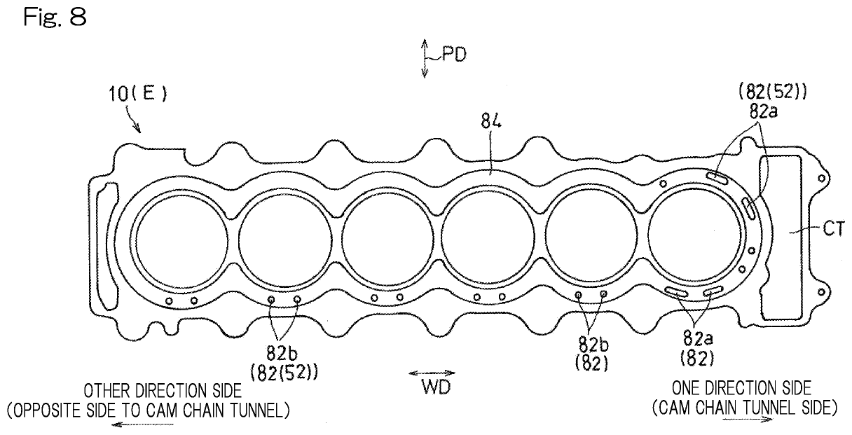

The inner passage 52 comprises a plurality of liquid coolant upward passages 82 which directs the liquid coolant from the cylinder block 10 towards the cylinder head 8 in the reciprocating direction. As illustrated in FIG. 8, the plurality of liquid coolant upward passages 82 are adjacently provided along the widthwise direction WD of the engine and along the cylinders. The liquid coolant directed into the inner passage 52 through the inlet 56 is delivered through the liquid coolant upward passages 82 into the plug circulation passage 80. It should be noted that FIG. 8 is a view of the cylinder block 10 from the side of the cylinder head 8 along the axes of the cylinders with the cylinder head 8 removed.

In the instant embodiment, among the plurality of liquid coolant upward passages 82, one or more liquid coolant upward passages 82a on the one side (or the cam chain tunnel-side) of the engine E in the widthwise direction WD of the engine provide a flow resistance smaller than the other liquid coolant upward passages 82b. In other words, the one or more liquid coolant upward passages 82a on a side of the engine E opposite to the outlet 58 provide a flow resistance smaller than the other liquid coolant upward passages 82b. In this context, “one or more liquid coolant upward passages 82a on the one side (or the cam chain tunnel-side) in the widthwise direction WD of the engine” refer to one or more liquid coolant upward passages 82a that are defined along one or more of the cylinders on the cam chain tunnel-side.

In the instant embodiment, the cross-sectional areas of the one or more liquid coolant upward passages 82a on the cam chain tunnel-side in the widthwise direction WD of the engine are larger than the cross-sectional areas of the other liquid coolant upward passages 82b to provide a flow resistance smaller than the latter. In this context, the “cross-sectional areas of the one or more liquid coolant upward passages 82a on the cam chain tunnel-side” refer to the sum of the cross-sectional areas of the same, when there are more than one such liquid coolant upward passage 82a.

A gasket 84 is interposed between the cylinder block 10 and the cylinder head 8. In the instant embodiment, the gasket 84 partially blocks one or more of openings of the liquid coolant upward passages 82 to adjust the cross-sectional areas of the liquid coolant upward passages 82 such that the one or more liquid coolant upward passages 82a on the cam chain tunnel-side provide a flow resistance smaller than the other liquid coolant upward passages 82b. This is only one of the non-limiting examples of how the liquid coolant upward passages 82 can have different cross-sectional areas. In addition to or as an alternative to different cross-sectional areas, the liquid coolant upward passages 82 may achieve different flow resistances by, for example, positioning a resistive element in at least one of the liquid coolant upward passages 82.

By thus configuring the one or more liquid coolant upward passages 82a on the cam chain tunnel-side to provide a flow resistance smaller than the other liquid coolant upward passages 82b, the liquid coolant can be preferentially delivered to the one or more liquid coolant upward passages 82a on the cam chain tunnel-side. As a result, an intense flow FL of the liquid coolant from the cam chain tunnel-side towards the outlet 58 on the counter-cam chain tunnel-side is induced in the plug circulation passage 80, as highlighted in FIG. 7. In this way, the bosses 35 for the plug holes 34 for the ignition plugs 26 are effectively cooled.

According to the configuration described so far, two ignition plugs 30, 32 are disposed per each cylinder, in particular, per each combustion chamber 20, as depicted in FIG. 6. This can normally achieve reliable combustion, and also, can ensure that, even in the event where one 30 (32) of the ignition plugs does not function correctly, the other 32 (30) of the ignition plugs provides ignition performance. As a result, the reliability of the engine E is improved. Further, by disposing the second ignition plugs 32 away from the transmission member housing space CT, the space between the combustion chambers 20 and a side of the engine E opposite to the transmission member housing space CT can be filled therewith in a packed manner, thereby reducing the width of the engine E.

In the instant embodiment, the second ignition plugs 32 are offset on the same side in the widthwise direction WD of the engine for each of the cylinders. If the second ignition plugs 32 were offset in different directions for different cylinders, there is a risk that the second ignition plugs 32 for adjoining cylinders might interfere with each other. According to the configuration under consideration, since the second ignition plugs 32 are not offset in different directions for different cylinders, the second ignition plugs 32 for adjoining cylinders do not interfere with each other.

In the instant embodiment, the second ignition plugs 32 coincide in position with the first ignition plugs 30 in the perpendicular direction PD such that the first and second ignition plugs 30, 32 are arranged aligned in the widthwise direction WD of the engine. Also, the cylinder head 8 includes the circulation path 50 defined therein in which the liquid coolant flows in circulation to cool the first and second ignition plugs 30, 32, and the outlet 58 of the circulation path 50 is defined in a counter-cam chain tunnel-side end of the cylinder head 8 in the widthwise direction WD of the engine. Such a configuration facilitates the generation of a flow of the liquid coolant going in the widthwise direction WD of the engine. Since the ignition plugs 26 are aligned in a row along such a flow in the widthwise direction, this flow cannot be blocked by the bosses 35 for the ignition plugs 26.

In the instant embodiment, as illustrated in FIG. 7, the outlet 58 of the circulation path 50 is located at a counter-cam chain tunnel-side end of the engine E. According to this configuration, the engine can be reduced in size in the widthwise direction WD as compared to when the outlet 58 is located at a cam chain tunnel-side end of the engine E.

In the instant embodiment, the inlet 56 of the circulation path 50 is defined in a portion of a wall surface of the cylinder block 10, the outlet 58 of the circulation path 50 is defined on a counter-cam chain tunnel-side portion of the engine E, and the liquid coolant flows in via the inlet 56 and through the plurality of liquid coolant upward passages 82 so that it is delivered to the plug circulation passage 80. Among the plurality of liquid coolant upward passages 82, one or more liquid coolant upward passages 82a which are located closer to the cam chain tunnel CT provide a flow resistance smaller than the other liquid coolant upward passages 82b. According to this configuration, the liquid coolant can flow without being stagnant from the side of the cam chain tunnel CT towards the outlet 58 which is on a side of the engine E opposite thereto, thus, providing efficient cooling of portions surrounding the ignition plugs 26.

In the instant embodiment, as illustrated in FIG. 8, the gasket 84 is interposed between the cylinder block 10 and the cylinder head 8 so as to partially block one or more of openings of the plurality of the liquid coolant upward passages 82. This is done to adjust cross-sectional areas of the liquid coolant upward passages 82 in such a way that one or more liquid coolant upward passages 82a which are located closer to the cam chain tunnel CT provide a flow resistance smaller than the other liquid coolant upward passages 82b. This configuration can provide a simple way to set the volume of the liquid coolant passing through the liquid coolant upward passages 82.

In the instant embodiment, as illustrated in FIG. 4, the coupling 66 is fitted on the inlet 56 of the circulation path 50, and the coupling 66 and the thermostat case 65 accommodating the thermostat 60 are constructed as one piece. Conventionally, a thermostat 60 is often provided at an outlet 58 of a circulation path 50. In the instant embodiment, in contrast, the outlet 58 of the circulation path 50 is located at one of the opposite ends of the engine E in the widthwise direction of the engine to achieve an improved cooling performance for the ignition plugs 26. This, however, makes it more challenging to integrate the outlet 58 and the thermostat case 65 into one piece (or to accommodate a consequent increase in size). According to the configuration under consideration, the thermostat case 65 and the coupling 66 fitted on the inlet 56 of the circulation path 50 are constructed as one piece, thereby achieving a reduced parts count. Consequently, the improved cooling performance for the ignition plugs 26 and the reduced parts count can be realized at the same time.

In the instant embodiment, as illustrated in FIG. 5, the plug holes 34 having the cords 44 of the ignition plugs 26 arranged therein are defined in the cylinder head 8 and the head cover 12 and extend in the reciprocating direction VD, and the cords 44 of the ignition plugs 26 are drawn out away from the high-pressure pump 24 relative to the ignition plugs 26 in the perpendicular direction PD. This configuration can prevent interference between the cords 44 of the ignition plugs 26 and the high-pressure pump 24. Further, the high-pressure pump 24 is driven by the exhaust-side components of the valve operation control mechanism 21. This assists in prevention of interference between a fuel piping located on the air intake side and pathways leading to the high-pressure pump 24.

The above-described configurations are only some of the non-limiting configurations of the present disclosure. Numerous additions, modifications, or omissions can be made therein without departing from the principle of the present disclosure. By way of example, the engine E in the embodiment described thus far can also be applied to saddle-riding vehicles including motorcycles, three-wheeled vehicles, and four-wheel buggies (or all-terrain vehicles). The engine E may be used in outboard motors or used as a propulsion source for an aircraft. In addition, the engine E may be used as a propulsion source for four-wheeled vehicles and small planing boats. The number of the cylinders does not necessarily have to be six and may, instead, be less than six or more than six. The engine E may be provided with a turbocharger, a supercharger, or other similar device(s). Thus, such variants are also encompassed within the scope of the present disclosure.

What is claimed is:

1. An engine comprising:
a crankshaft extending in a widthwise direction of the engine and converting reciprocal motions of pistons to produce rotary motion;
a crankcase supporting the crankshaft;
a plurality of cylinders extending from the crankcase so as to protrude in a reciprocating direction of the pistons, the cylinders being arranged along the widthwise direction of the engine;
a cylinder head coupled to protruding ends of the cylinders, the cylinders and the cylinder head defining combustion chambers therein;
air intake ports which introduce intake air to the combustion chambers;
air intake valves which open and close the air intake ports;
exhaust ports which discharge exhaust gas from the combustion chambers;
exhaust valves which open and close the exhaust ports;
a valve operation control mechanism which opens and closes the air intake valves and the exhaust valves in a synchronous manner with the rotary motion of the crankshaft;
a power transmission member which transfers the rotary motion of the crankshaft to the valve operation control mechanism;
a transmission member housing space defined by the cylinders and the cylinder head, extending in the reciprocating direction, and having the power transmission member disposed therein; and
ignition plugs which ignite an air-fuel mixture in the combustion chambers, the ignition plugs including first and second ignition plugs for each of the combustion chambers, the first ignition plug being located on the cylinder axis, and the second plug being arranged offset relative to the first ignition plug so as to be away from the transmission member housing space in the widthwise direction of the engine.

2. The engine as claimed in claim 1, wherein the second ignition plug is offset on the same side in the widthwise direction of the engine for each of the cylinders.

3. The engine as claimed in claim 1, wherein
the second ignition plug coincides in position with the first ignition plug in a direction perpendicular to both the reciprocating direction and the widthwise direction of the engine such that the first and second ignition plugs are arranged aligned in the widthwise direction of the engine,
the cylinder head includes a circulation path defined therein in which a liquid coolant flows in circulation to cool the first and second ignition plugs, and
the circulation path has an inlet and an outlet, one of which is defined in one of opposite ends of the cylinder head in the widthwise direction of the engine.

4. The engine as claimed in claim 3 wherein
the transmission member housing space is located at one end of the engine in the widthwise direction of the engine, and
one of the inlet and the outlet of the circulation path is located at an end of the engine opposite to the transmission member housing space in the widthwise direction of the engine.

5. The engine as claimed in claim 3, further comprising:
the inlet of the circulation path being defined in an air intake side-portion of a wall surface of a cylinder block constituted by the plurality of cylinders;
the outlet of the circulation path being defined in a portion of the engine opposite to the transmission member housing space in the widthwise direction of the engine; and
a plurality of liquid coolant upward passages which direct a liquid coolant from the cylinder block towards the cylinder head in the reciprocating direction, one or more of the plurality of liquid coolant upward passages which are located closer to the transmission member housing space in the widthwise direction of the engine providing a flow resistance smaller than the other liquid coolant upward passages.

6. The engine as claimed in claim 5, further comprising:
a gasket interposed between the cylinder block and the cylinder head, the gasket partially blocking one or more of openings of the plurality of the liquid coolant upward passages to adjust cross-sectional areas of the liquid coolant upward passages such that the one or more of the liquid coolant upward passages which are located closer to the transmission member housing space provide a flow resistance smaller than the other liquid coolant upward passages.

7. The engine as claimed in claim 3, further comprising:
the inlet of the circulation path being defined in an air-intake side-portion of a wall surface of a cylinder block constituted by the plurality of cylinders;
the outlet of the circulation path being defined in a portion of the engine opposite to the transmission member housing space in the widthwise direction of the engine;
a coupling fitted on the inlet of the circulation path; and
a thermostat case accommodating a thermostat which regulates a temperature of the liquid coolant, the coupling and the thermostat case being constructed as one piece.

8. The engine as claimed in claim 1, further comprising:
a head cover coupled to an end of the cylinder head in the reciprocating direction;
plug holes defined in the cylinder head and the head cover, extending in the reciprocating direction, and having cords of the ignition plugs arranged therein; and
a protruding part coupled to the head cover so as to protrude from the head cover, the cords of the ignition plugs being drawn out away from the protruding part relative to the ignition plugs in a direction perpendicular to both the reciprocating direction and the widthwise direction of the engine.

9. The engine as claimed in claim 8, further comprising:
direct injection injectors which inject fuel directly into the combustion chambers, the protruding part comprising a high-pressure pump which pumps the fuel to the direct injection injectors.

10. The engine as claimed in claim 9, wherein the valve operation control mechanism comprises air intake side-components and exhaust-side components, and the high-pressure pump is either driven by the air intake-side components or the exhaust-side components of the valve operation control mechanism.
